(19) United States
(12) Patent Application Publication
(10) Pub. No.: US 2014/0364070 A1
(43) Pub. Date: Dec. 11, 2014

(54) COMMUNICATION DEVICE

(71) Applicant: TAIYO YUDEN CO., LTD., Tokyo (JP)

(72) Inventors: Hirotaka TAKEUCHI, Tokyo (JP); Makoto INOUE, Tokyo (JP); Takashi AMANO, Tokyo (JP)

(73) Assignee: TAIYO YUDEN CO., LTD., Tokyo (JP)

(21) Appl. No.: 14/102,322

(22) Filed: Dec. 10, 2013

(30) Foreign Application Priority Data
Jun. 5, 2013 (JP) 2013-118812

(51) Int. Cl. H04B 7/12

(52) U.S. Cl. CPC H04B 7/12
USPC 455/77

(57) ABSTRACT

Electrodes are formed of a nonmagnetic metal in high-frequency electronic components that conduct high frequency electric current having a frequency included in any of a first frequency band for transmitting and a third frequency band for receiving, both assigned to a first transmitting/receiving unit for data communication, and a second frequency band for transmitting and a fourth frequency band for receiving, both assigned to a second transmitting/receiving unit for telephone communication. The high-frequency electronic components also restrict the frequency of the conducted electric current.

### CROSS-REFERENCE TO RELATED APPLICATIONS

This application is based on and claims the benefit of priority from Japanese Patent Application Serial No. 2013-118812, filed on Jun. 5, 2013, the contents of which are hereby incorporated by reference in their entirety.

### TECHNICAL FIELD

The present disclosure relates to a communication device that handles a plurality of communications simultaneously.

### BACKGROUND

Recently, smart media devices typified by mobile phones (smartphones) serving as mobile terminals have developed remarkably, bringing significant shifts in standards applied to these devices.

One of these standards is Long Term Evolution (LTE) for handling data communication, which uses an increasing range of frequencies along with existing telephone communication. In particular, Simultaneous Voice and LTE (SVLTE) handles cellular communication and data communication simultaneously.

FIG. 23 shows a basic configuration of such a communication device that handles telephone communication and data communication simultaneously. In the communication device 1 shown in FIG. 23, the data communication band (Band 1) ranges from 777 to 787 MHz for transmission frequency f1 and from 746 to 756 MHz for receiving frequency f3; and the telephone communication band (Band 2) ranges from 824 to 849 MHz for transmission frequency f2 and from 869 to 894 MHz for receiving frequency f4. These frequencies are allocated by communication standards for mobile phones.

The communication device 1 includes a first transmitting/receiving unit 100 for the data communication band (Band 1), a second transmitting/receiving unit 200 for the telephone communication band (Band 2), and an audio-data processing unit 300. The feeding point of an antenna 111 of the first transmitting/receiving unit 100 is connected to an antenna output terminal of a duplexer 113 via a matching circuit 112. A receiving terminal of the duplexer 113 is connected to a mixer 116 via a low-noise amplifier 114; a received signal inputted into the mixer is mixed with a local oscillation signal outputted from an oscillator 118 and then inputted into an A/D converter circuit for data communication in the audio-data processing unit 300 via a filter 119.

Meanwhile, a transmitting terminal of the duplexer 113 is connected to an output terminal of a high-frequency amplifier 115; an input terminal of the high-frequency amplifier 115 is connected to an output terminal of a mixer 117; an input terminal of the mixer 117 is connected to an output of a D/A converter circuit for data communication of the audio-data processing unit 300 via a filter 120. Further, a local oscillation signal is inputted from the oscillator 118 into the mixer 117.

The feeding point of an antenna 211 of the second transmitting/receiving unit 200 is connected to an antenna output terminal of a duplexer 213 via a matching circuit 212. A receiving terminal of the duplexer 213 is connected to a mixer 216 via a low-noise amplifier 214; a received signal inputted into the mixer is mixed with a local oscillation signal outputted from an oscillator 218 and then inputted into an A/D converter circuit for telephone communication in the audio-data processing unit 300 via a filter 219.

Meanwhile, a transmitting terminal of the duplexer 213 is connected to an output terminal of a high-frequency amplifier 215; an input terminal of the high-frequency amplifier 215 is connected to an output terminal of a mixer 217; an input terminal of the mixer 217 is connected to an output of a D/A converter circuit for telephone communication of the audio-data processing unit 300 via a filter 220. Further, a local oscillation signal is inputted from the oscillator 218 into the mixer 217.

The communication device 1 described above can simultaneously use the data communication circuit and the telephone communication circuit, and thus permits data communication and telephone communication simultaneously.

However, various problems are arising in Simultaneous Voice and LTE (SVLTE) which handles cellular communication and data communication simultaneously.

One example of such problems occurs in the case where signals of 785 MHz are received in LTE (Band 1) for data communication while a transmitter is transmitting signals of 824 MHz in the cellular communication (BC0) for audio communication (telephone communication). Referring to FIG. 24, when two signals overlap with each other in a high frequency circuit shared by the transmitter and the receiver, a distorted frequency component near the basic frequency component is produced. That is, two signal 3rd-order intermodulation distortion (also referred to as IMD3, or as PIM3 when produced in passive parts) is produced. When such intermodulation distortion is produced in a receiving band, the reproducibility of received signals is degraded.

For example, when the band of LTE (Band 1) for data communication has a transmission frequency f1 of 785 MHz, and the band of cellular communication (Band 2) for telephone communication has a transmission frequency f2 of 824 MHz, the frequencies of 2nd-order intermodulation distortion and 3rd-order intermodulation distortion are the following (1) to (4).

(1) and (2)—3rd intermodulation distortion
(3) and (4)—2nd intermodulation distortion

2f1−f2=2×785−824=746 MHz(the receiving frequency band for data communication) (1)

2f2−f1=2×824−785=863 MHz(near the receiving frequency for telephone communication) (3)

f2+f1=785+824=1,609 MHz (3)

f2−f1=824−785=39 MHz (4)

In this case, the above frequency (1) of 3rd-order intermodulation distortion is produced in the receiving frequency band of LTE for data communication, and the above frequency (2) of 3rd-order intermodulation distortion is produced near the receiving frequency of cellular communication for telephone communication.

For another example, when the band of LTE (Band 1) for data communication has a transmission frequency f1 of 779 MHz, and the band of cellular communication (Band 2) for telephone communication has a transmission frequency f2 of 824 MHz, the frequencies of 2nd-order intermodulation distortion and 3rd-order intermodulation distortion are the following (5) to (8).

(5) and (6)—3rd intermodulation distortion
(7) and (8)—2nd intermodulation distortion

2f1−f2=2×779−824=734 MHz(near receiving frequency for data communication) (5)

2f2−f1=2×824×779=869 MHz(the receiving frequency band for telephone communication) (6)

f1+f2=779+824=1,603 MHz (7)

f2−f1=824−779=45 MHz (8)

In this case, the above frequency (5) of 3rd-order intermodulation distortion is produced in the receiving frequency band of LTE for data communication, and the above frequency (6) of 3rd-order intermodulation distortion is produced near the receiving frequency of cellular communication for telephone communication.

As shown in FIG. 25, the frequency components of (f1+f2) and (f2−f1) of 2nd-order intermodulation distortion and (2f1+f2) and (2f2+f1) of 3rd-order intermodulation distortion are less likely to cause problems; in contrast, the frequency components of (2f1−f2) and (2f2−f1) of 3rd-order intermodulation distortion, positioned near the receiving frequency for telephone communication or the receiving frequency for data communication, are difficult to remove by a filter and likely to cause problems.

In particular, the above 3rd-order intermodulation distortion causes a critical problem in mobile phones and other devices as disturbing waves in receiving bands; and measures against these problems such as large backoff may reduce efficiency.

The importance of intermodulation distortion will be increased as more frequencies are used when LTE is replaced with LTE-Advanced in the future.

Examples of known methods of suppressing 3rd-order intermodulation distortion are disclosed in Japanese Patent Application Publication No. Hei 11-68697 (the “'697 Publication”) and International Publication No. WO 2007/123040 (the “'040 Publication”).

### SUMMARY

The method disclosed in the '697 Publication suppresses intermodulation distortion in a mobile phone device. This method measures receiving signal strength, pilot signal strength, and code error rate of signals, and controls the receiving band to lower the band of signals of 3rd-order intermodulation distortion in an amplifier or a frequency converter in the receiving circuit. However, it is difficult to apply this method to a communication device that handles telephone communication and data communication simultaneously, because the circuit configuration becomes complex.

Meanwhile, the method disclosed in the '040 Publication is applied to a wireless transmitter for high-speed communication. This method includes producing 3rd-order intermodulation distortion having a reverse phase difference from two primary signals having different frequencies, amplifying a signal in an output circuit, amplifying a signal including the 3rd-order intermodulation distortion, and combining these signals with a mixer to cancel the 3rd-order intermodulation distortion. However, it is difficult to apply this method to a communication device that handles telephone communication and data communication simultaneously, because the circuit configuration becomes complex.

One object of the present disclosure is to provide a communication device that permits simultaneous communication of audio and data while suppressing 3rd-order intermodulation distortion, thereby to overcome the above problems.

To attain the above object, the present disclosure proposes a communication device comprising: a first transmitting/receiving unit configured to transmit a radio wave having a first frequency f1 within a first frequency band and receive a radio wave having a third frequency f3 within a third frequency band different from the first frequency band; and a second transmitting/receiving unit configured to transmit a radio wave having a second frequency f2 within a second frequency band different from the first and third frequency bands and receive a radio wave having a fourth frequency f4 within a fourth frequency band different from the first to third frequency bands, wherein the first transmitting/receiving unit and the second transmitting/receiving unit are capable of transmitting or receiving simultaneously, the first to fourth frequency bands are set such that a frequency component of any one of a plurality of 3rd-order intermodulation distortions produced from the first frequency f1 and the second frequency f2 is included in at least one of the third frequency band and the fourth frequency band used as receiving frequency bands, and high-frequency electronic components conducting high frequency electric current having a frequency within any of the first to fourth frequency bands have electrodes formed of a nonmagnetic metal.

In the present disclosure, the electrodes of the high-frequency electronic components that conduct high frequency electric current having a frequency within the first to fourth frequency bands are formed of a nonmagnetic metal; and thus, an external electrode that conducts the high frequency electric current has a small conductivity p and a small relative permeability μ that suppress impact of the skin effect, and is made of a material having a deep skin depth δ, and undergoes a small variation in the relative permeability μ within a temperature range from 260 to 350° C. Therefore, the current density in the skin layer is not high. This is generally known as shown in FIG. 26. The values shown in FIG. 26 are measured at a frequency of 2,450 MHz. Such nonmagnetic electrodes suppress 3rd-order intermodulation distortion to a level acceptable for a communication device that handles telephone communication and data communication simultaneously.

### BRIEF DESCRIPTION OF THE DRAWINGS

FIG. 1 is a block diagram of an electric circuit representing a communication device according to an embodiment of the present disclosure.

FIG. 2 is a sectional view of a filter used in a communication device according to an embodiment of the present disclosure.

FIG. 3 is a sectional view of a filter used in a communication device according to an embodiment of the present disclosure.

FIG. 4 is an exploded perspective view of a filter used in a communication device according to an embodiment of the present disclosure.

FIG. 5 is a diagram showing an electric circuit of a filter used in a communication device according to an embodiment of the present disclosure.

FIG. 6 is a diagram showing a measurement circuit for 3rd-order intermodulation distortion of a filter used in a communication device according to an embodiment of the present disclosure.

FIG. 7 is a diagram showing a measurement result of 3rd-order intermodulation distortion of a filter used in a communication device according to an embodiment of the present disclosure.

FIG. 8 is a diagram showing measurement conditions of 3rd-order intermodulation distortion of a filter used in a communication device according to an embodiment of the present disclosure.

FIG. 9 is an exploded perspective view of a diplexer that can be used in a communication device according to an embodiment of the present disclosure.

FIG. 10 is a diagram showing an electric circuit of a diplexer that can be used in a communication device according to an embodiment of the present disclosure.

FIG. 11 is a diagram showing a measurement circuit for 3rd-order intermodulation distortion of a diplexer that can be used in a communication device according to an embodiment of the present disclosure.

FIG. 12 is a diagram showing a measurement result of 3rd-order intermodulation distortion of a diplexer that can be used in a communication device according to an embodiment of the present disclosure.

FIG. 13 is a diagram showing measurement conditions of 3rd-order intermodulation distortion of a diplexer that can be used in a communication device according to an embodiment of the present disclosure.

FIG. 14 is a perspective view of an inductor used in a communication device according to an embodiment of the present disclosure.

FIG. 15 is a diagram showing an electric circuit of an inductor used in a communication device according to an embodiment of the present disclosure.

FIG. 16 is an exploded perspective view of an inductor used in a communication device according to an embodiment of the present disclosure.

FIG. 17 is a diagram showing a measurement circuit for 3rd-order intermodulation distortion of an inductor used in a communication device according to an embodiment of the present disclosure.

FIG. 18 is a diagram showing a measurement result of 3rd-order intermodulation distortion of an inductor used in a communication device according to an embodiment of the present disclosure.

FIG. 19 is a diagram showing measurement conditions of 3rd-order intermodulation distortion of an inductor used in a communication device according to an embodiment of the present disclosure.

FIG. 20 is a diagram explaining the total value of 3rd-order intermodulation distortion produced when high frequency electronic components are connected in series.

FIG. 21 is a diagram showing a measurement result of 3rd-order intermodulation distortion produced by the printed wiring on a circuit board of a communication device according to an embodiment of the present disclosure.

FIG. 22 is a diagram showing measurement conditions of 3rd-order intermodulation distortion produced by the printed wiring on a circuit board of a communication device according to an embodiment of the present disclosure.

FIG. 23 is a block diagram of an electric circuit representing a conventional communication device.

FIG. 24 is a diagram illustrating 2nd-order and 3rd-order intermodulation distortion produced in a conventional communication device.

FIG. 25 is a diagram illustrating 3rd-order intermodulation distortion produced within a receiving frequency band of a conventional communication device.

FIG. 26 is a diagram showing relative permeabilities and depths of penetration of various materials.

### DESCRIPTION OF EXAMPLE EMBODIMENTS

An embodiment of the present disclosure will now be described with reference to the attached drawings.

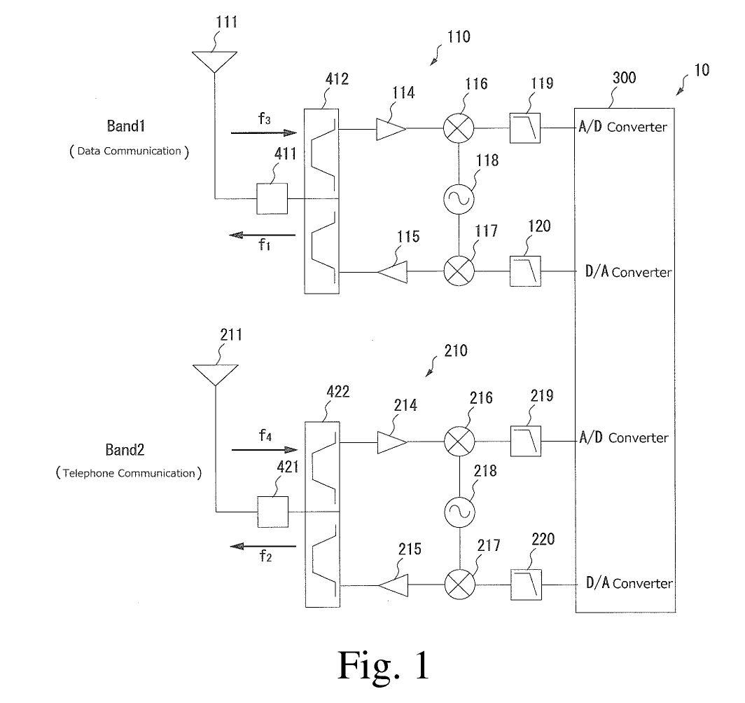

FIG. 1 is a block diagram of an electric circuit representing a communication device according to an embodiment of the present disclosure. A mobile phone (smartphone) will be taken as an example of a communication device according to this embodiment.

In the drawings, the same components as those in the above-described conventional communication device are denoted by the same numerals. The difference between the communication device 10 according to this embodiment and the conventional communication device 1 may be that, in the former, external terminal electrodes and internal electrodes of high frequency electronic components disposed between the antenna and mixer of each transmitting/receiving circuit are formed only of a nonmagnetic material.

The communication device 10 includes a first transmitting/receiving unit 110 for the data communication band (Band 1), a second transmitting/receiving unit 210 for the telephone communication band (Band 2), and an audio-data processing unit 300.

The feeding point of an antenna 111 of the first transmitting/receiving unit 110 may be connected to an antenna connection terminal of a duplexer 412 via a matching circuit 411. A receiving terminal of the duplexer 412 may be connected to a mixer 116 via a low-noise amplifier 114; a received signal inputted into the mixer 116 may be mixed with a local oscillation signal outputted from an oscillator 118 and then inputted into an A/D converter circuit for data communication in the audio-data processing unit 300 via a filter 119.

Meanwhile, a transmitting terminal of the duplexer 412 is connected to an output terminal of a high-frequency amplifier 115; an input terminal of the high-frequency amplifier 115 is connected to an output terminal of a mixer 117; an input terminal of the mixer 117 is connected to an output of a D/A converter circuit for data communication of the audio-data processing unit 300 via a filter 120. Further, a local oscillation signal may be inputted from the oscillator 118 into the mixer 117.

The feeding point of an antenna 211 of the second transmitting/receiving unit 210 may be connected to an antenna connection terminal of a duplexer 422 via a matching circuit 421. A receiving terminal of the duplexer 422 is connected to a mixer 216 via a low-noise amplifier 214; a received signal inputted into the mixer is mixed with a local oscillation signal outputted from an oscillator 218 and then inputted into an A/D converter circuit for telephone communication in the audio-data processing unit 300 via a filter 219.

Meanwhile, a transmitting terminal of the duplexer 422 is connected to an output terminal of a high-frequency amplifier 215; an input terminal of the high-frequency amplifier 215 is connected to an output terminal of a mixer 217; an input terminal of the mixer 217 is connected to an output of a D/A converter circuit for telephone communication of the audio-data processing unit 300 via a filter 220. Further, a local oscillation signal may be inputted from the oscillator 218 into the mixer 217.

The communication device 10 described above can simultaneously use the data communication circuit and the telephone communication circuit, and thus permits data communication and telephone communication simultaneously.

In the communication device 10, the data communication band (Band 1) may range from 777 to 787 MHz for transmission frequency f1 and from 746 to 756 MHz for receiving frequency f3; and the telephone communication band (Band 2) ranges from 824 to 849 MHz for transmission frequency f2 and from 869 to 894 MHz for receiving frequency f4. These frequencies are allocated by communication standards for mobile phones.

The above matching circuits 411, 421 may comprise a filter, an inductor, a capacitor, or a combination thereof, and may remove high frequency noises outside the used frequency range or match impedances between the antenna and the duplexer. These matching circuits may comprise, for example, a laminated ceramic electronic component, and the electrodes of these matching circuits may be formed only of a nonmagnetic material.

The above duplexers 412, 422 may demultiplex the transmitting/receiving frequencies, and may comprise, for example, an electronic component including a ceramic substrate and a component placed thereon; the component may include a comb electrode formed on the top surface of a lithium tantalate substrate; and the electrodes of the ceramic substrate may be formed only of a nonmagnetic material.

the low-noise amplifier 114, 214 may amplify signals of low levels and reduce the impacts of noises.

The high frequency amplifier 115, 215 may amplify signals outputted from the mixers 117, 217 into high-output signals.

The mixers 116, 216 may constitute downconverters along with the oscillator 118, 218 to convert high frequency signals into low frequency signals.

The mixers 117, 217 may constitute upconverters along with the oscillator 118, 218 to convert low frequency signals into high frequency signals.

The filters 119, 120, 219, 220 may remove noises outside the used frequency range.

The audio-data processing unit 300 may process audio signals and data signals.

In the above arrangement, the internal electrodes and the external electrodes of the matching circuits 411, 421 and the duplexer 412, 422 including laminated ceramic high-frequency electronic components combined together may be formed of a nonmagnetic material at positions between the antennas 111, 211 and the mixers 116, 117, 216, 217.

The communication device 10 of the present disclosure that permits simultaneous communication of audio and data may operate at a wide range of frequencies from 450 MHz to 3,800 MHz, while suppressing the level of 3rd-order intermodulation distortion (IMD3) to about −118 dBm or lower for the used frequency range.

Such electrodes may preferably have a conductivity ρ higher than 5×10⁷ (S/m), a relative permeability μs (μ/μ0) of about 1.0, and a skin depth δ of 1.0 μm or larger for the used frequency range. Within these numerical ranges, the above effect may almost be obtained. In addition to such an electrical property, the above electrodes may also have an excellent solderability (Wetting balance test).

Next, specific examples of high-frequency electronic components applicable to the communication device 10 of the present disclosure will now be described.

### Embodiment 1

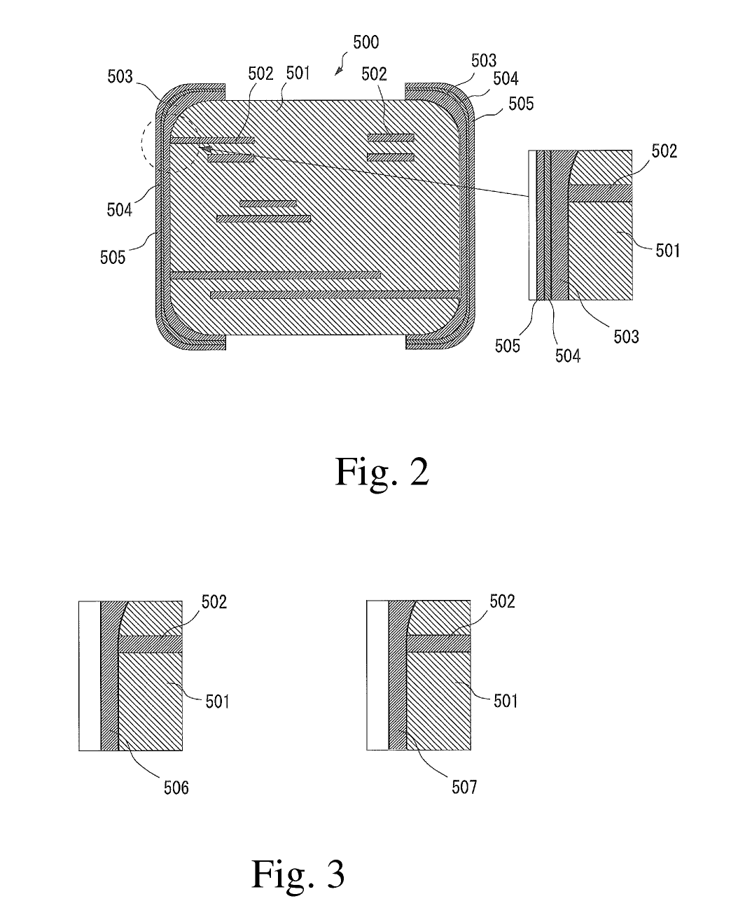

FIGS. 2 to 8 explains a filter 500 comprising a high-frequency electronic component that can be used in the matching circuits 411, 421 of the communication device 10. As shown in FIG. 2, the filter 500 may comprise a laminated ceramic electronic component that may have a plurality of internal electrodes 502 inside a body 501 and external electrodes electrically connected to the internal electrodes 502 on an outer surface of the body 501.

For example, the internal electrodes 502 may be formed of silver (Ag); and the external electrodes may comprise: a silver (Ag) terminal electrode 503 provided on the surface of the body 501 formed of a ceramic layer so as to be electrically connected to the internal electrodes 502; a copper (Cu) plated layer 504 provided on the surface of the terminal electrode 503; and a tin (Sn) plated layer 505 provided on the surface of the copper (Cu) plated layer 504.

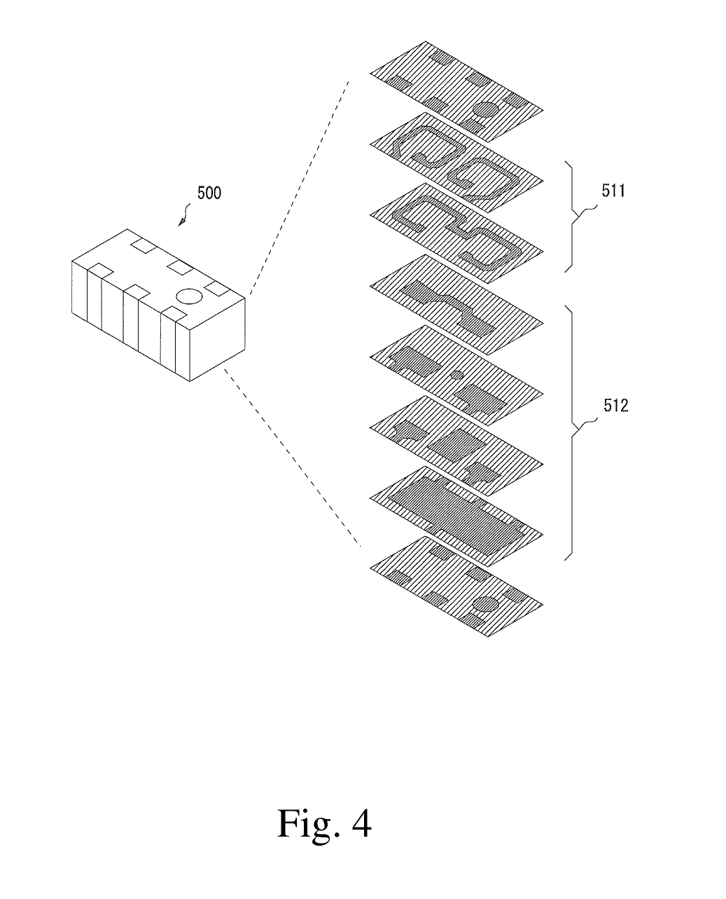

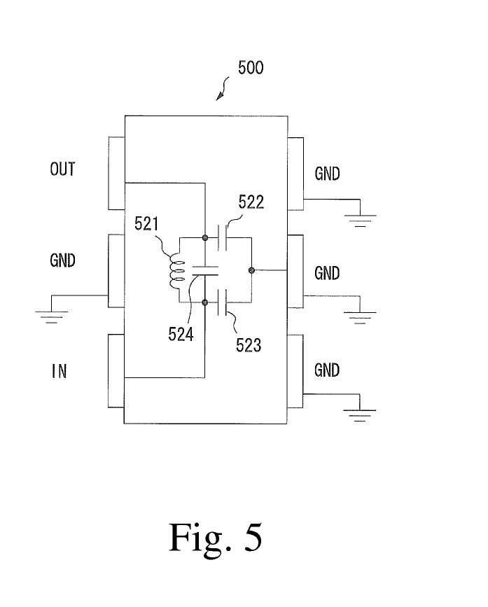

As shown in FIG. 4, the body 501 may comprise a plurality of dielectric layers stacked together, each having formed thereon a nonmagnetic internal electrode. These internal electrodes may constitute an inductor unit 511 and a capacitor unit 512. The inductor unit 511 may include an inductor 521 shown in FIG. 5; and the capacitor unit 512 may include capacitors 522 to 524.

Embodiment 1 may have the following features (A1) to (A4). (A1) The electrodes may comprise a metal having a relative permeability of 1.1 or lower. (A2) The internal electrodes may comprise a metal that can be baked simultaneously with the ceramic in the dielectric layers. (A3) The portions of the external electrodes contacting the ceramic may basically comprise a baked electrode. (A4) On the baked electrode of the external electrode may be provided a metal having an excellent soldering property by plating.

Following is an example of a process of manufacturing the internal electrodes 502 and the external electrodes of the filter 500 comprising the laminated ceramic electronic component according to this embodiment. The first step may be to prepare a ceramic green sheet for forming the body 501 comprising the dielectric shown in the figures after baking. First, slurry may be prepared. In general, dielectric slurry may comprise organic solvent-based slurry including a ceramic powder and an organic vehicle kneaded together. The ceramic powder may be a mixture of various oxidizable compounds such as carbonate, nitrate, hydroxide, and organic metal compounds. In general, the ceramic powder may have an average particle size of 0.5 μm or smaller.

An organic vehicle is a binder dissolved in an organic solvent. A binder used in the organic vehicle is not particularly limited and may be various ordinary binders such as ethyl cellulose, polyvinyl butyral, and acrylic resins.

The slurry may contain an additive selected from various dispersants, plasticizers, glass frits, and antifoams, as necessary. The total content of these additives may preferably be 10 mass % or less. The slurry may be used to form a green sheet on a carrier sheet to a thickness of about 80 μm by the doctor blade method. Such a thickness may enable the baked dielectric layer and magnetic layer to have a thickness of about 60 μm.

The green sheet may be dried after being formed on the carrier sheet. The drying temperature of the green sheet may preferably be 50 to 150° C.; and the drying time of the green sheet may preferably be 1 to 20 minutes. The thickness of the green sheet after the drying may be 5 to 25% of the thickness before the drying.

The carrier sheet may be, for example, a PET film coated with silicon to improve release quality.

On the surface of the green sheet may be formed a conductive paste film in a particular pattern with a thickness of about 3 to 5 μm. The conductive paste film may be formed by the screen printing method or the gravure printing method to form an unbaked internal electrode layer on the surface of the green sheet.

The paste may be prepared by kneading together a conductive material powder, an inorganic oxide powder used as a common base, and an organic vehicle.

The conductive material powder may preferably comprise at least one material selected from silver, palladium, copper, and copper alloys, but not limited thereto. In most cases, the ratio of silver to palladium may be about 7:3.

The conductive paste for internal electrodes may include an inorganic oxide powder as a common base. Such an inorganic oxide powder may preferably be a ceramic powder having the same composition as the ceramic powder included in the above green sheet. The common base may suppress sintering of the conductive material powder in the baking process. The inorganic oxide powder used as a common material may have an average particle size of 0.1 to 1 μm.

The content of the inorganic oxide powder used as common base in the conductive paste for the internal electrodes may preferably be about 5 to 30 wt. parts relative to 100 wt. parts of the conductive material powder. When the content of the common base is too small, the sintering of the internal electrodes may begin at a low temperature, enlarging the difference in sintering temperature between the internal electrode layers, the dielectric layers, and the magnetic layers, and thus producing a baking crack. In contrast, when the content of the common base is too large, the conductivity of the internal electrodes may be reduced, and thus the characteristics of the internal electrodes may also be reduced.

The organic vehicle may preferably comprise ethyl cellulose, polyvinyl butyral, or polyvinyl acetal.

The solvent may be, for example, terpineol, butyl carbitol, kerosine, acetone, or isobornyl acetate. The content of the solvent in the paste for the internal electrodes may be about 25 to 55 wt %.

The paste for internal electrodes may preferably contain a plasticizer or an adhesive for improving the adhesiveness to the green sheet. Examples of the plasticizer include phthalate esters, adipate ester, phosphate ester, and glycols. The content of the plasticizer in the organic vehicle may be 50 to 250 wt. parts relative to 100 wt. parts of a binder. If the content of the plasticizer is too small, no effect may be produced from the addition; and if the content of the plasticizer is too large, the strength of the unbaked electrode film formed may be significantly reduced.

The conductive paste may preferably contain a dispersant for enhancing the dispersibility of the conductive material powder and the common base and improving the stability of the coating. Examples of the dispersant may include polyethylene glycol-based dispersants, polycarboxylic acid-based dispersants, polyol partial ester-based dispersants, ester-based dispersants, and ether-based dispersants. The content of the dispersant may preferably be 0.05 to 4 wt. parts relative to the 100 wt. parts of the total of the conductive material powder and the common material powder.

The conductive paste for the internal electrodes may be formed by kneading the above components together in a ball mill or a three-roll mill.

The next step is screen printing of the pasty internal electrode material on the green sheet. Subsequently, a plurality of such green sheets having the internal electrodes printed thereon may be stacked one over another with the electrode patterns accurately positioned. The stacked sheets may be pressed for pressure bonding and integration. At present, the dielectric may still not be fully dried, and may be sent to a baking furnace and baked at a temperature from 1,000 to 1,300° C. to be ceramic. The next step is to form external terminal electrodes. The external electrode material may be applied to chip sections of the body 501 where the internal electrodes 502 may be exposed; and the external electrode material may be baked to form external electrodes along with the copper (Cu) plated layer 504 and the tin (Sn) plated layer 505 subsequently provided thereon.

As shown in FIG. 3, the silver (Ag) terminal electrodes 503 may be replaced with Ag—Pt baked terminal electrodes 506 or Ag—Pd baked terminal electrodes 507 to avoid plating.

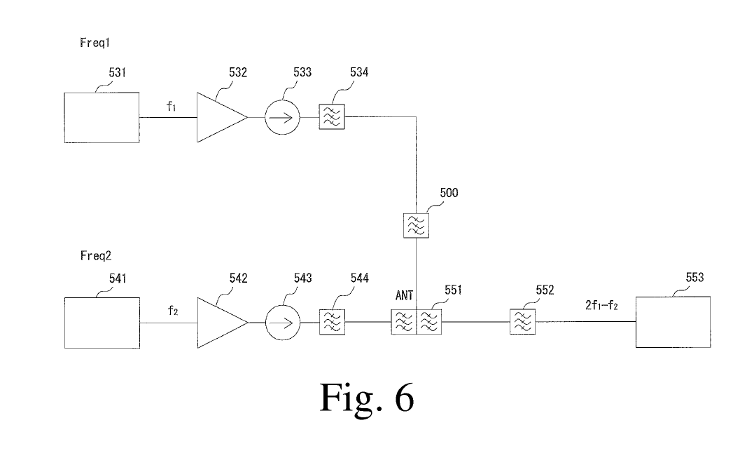

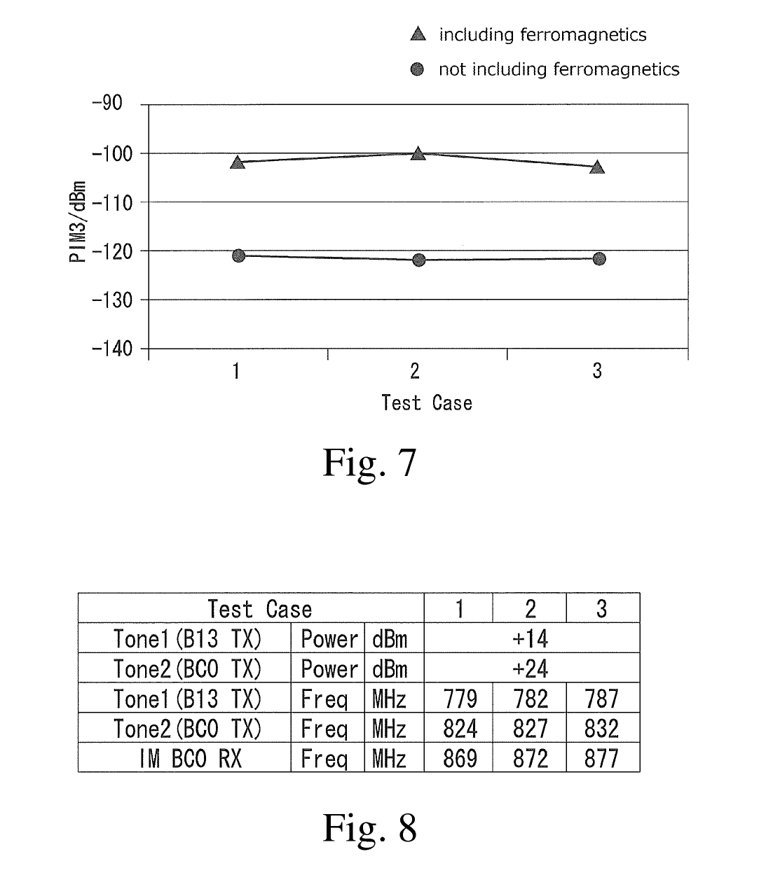

FIG. 7 shows the measurement result of 3rd-order intermodulation distortion produced by the filter 500 comprising the laminated ceramic electronic component having the electrodes formed of the nonmagnetic materials as described above. This measurement result was obtained with a measurement circuit shown in FIG. 6 under the measurement conditions shown in FIG. 8. In the filter 500 used in this embodiment, the internal electrodes may be formed of silver (Ag), and the external electrodes may be formed of silver (Ag) electrodes plated with copper and tin (Cu—Sn) on the surface.

As shown in FIG. 6, high-frequency signals generated by a signal generator 531 for generating a frequency f1 for data communication may be amplified by a signal amplifier 532 and then inputted into the filter 500 via an isolator 533 and a filter 534. The filter 500, the object of the measurement, may be in the 1608 size. The isolator 533 may protect the signal amplifier 532 against reflection signals; and the filter 534 may remove spurious signals.

High-frequency signals generated by a signal generator 541 for generating a frequency f2 for telephone communication may be amplified by a signal amplifier 542 and then inputted into one of input/output terminals of a duplexer 551 via an isolator 543 and a filter 544. The isolator 543 may protect the signal amplifier 542 against reflection signals; and the filter 544 may remove spurious signals. The signal outputted from the duplexer 551 may be inputted into the filter 500.

The other input/output terminal of the duplexer 551 may be connected to a signal meter 553 via a filter 552 for removing spurious signals. Thus, the signal meter 553 may receive a signal of the frequency of 3rd-order intermodulation distortion (2f1−f2).

The measurement was based on test cases 1 to 3. In test case 1, the high-frequency signals (Tone 1 (B13 TX)) generated by the signal generator 531 and having a frequency for data communication had a strength of +14 dBm and a frequency of 779 MHz; and the high-frequency signals (Tone 2 (BC0 TX)) generated by the signal generator 541 and having a frequency for telephone communication had a strength of +24 dBm and a frequency of 824 MHz. In this test case, the 3rd-order intermodulation distortion signals (PIM3) at a frequency of 869 MHz included in a receiving frequency band (BC0 RX) for telephone communication and generated by the filter 500 in the above Embodiment 1 had a strength of about −121 dBm. Under the same conditions, the 3rd-order intermodulation distortion signals (PIM3) at a frequency of 869 MHz included in a receiving frequency band (BC0 RX) for telephone communication and generated by a conventional filter having electrodes formed of a magnetic material had a strength of about −102 dBm. The internal electrodes of the above conventional filter was formed of silver (Ag); and the external electrodes comprised: a silver (Ag) terminal electrode provided on the surface of the component body so as to be electrically connected to the internal electrodes; a nickel (Ni) plated layer provided on the surface of the terminal electrode; and a tin (Sn) plated layer provided on the surface of the nickel (Ni) plated layer.

In test case 2, the high-frequency signals (Tone 1 (B13 TX)) generated by the signal generator 531 and having a frequency for data communication had a strength of +14 dBm and a frequency of 782 MHz; and the high-frequency signals (Tone 2 (BC0 TX)) generated by the signal generator 541 and having a frequency for telephone communication had a strength of +24 dBm and a frequency of 827 MHz. In this test case, the 3rd-order intermodulation distortion signals (PIM3) at a frequency of 872 MHz included in a receiving frequency band (BC0 RX) for telephone communication and generated by the filter 500 in the above Embodiment 1 had a strength of about −122 dBm. Under the same conditions, the 3rd-order intermodulation distortion signals (PIM3) at a frequency of 869 MHz included in a receiving frequency band (BC0 RX) for telephone communication and generated by a conventional filter having electrodes formed of a magnetic material had a strength of about −100 dBm.

In test case 3, the high-frequency signals (Tone 1 (B13 TX)) generated by the signal generator 531 and having a frequency for data communication had a strength of +14 dBm and a frequency of 787 MHz; and the high-frequency signals (Tone 2 (BC0 TX)) generated by the signal generator 541 and having a frequency for telephone communication had a strength of +24 dBm and a frequency of 832 MHz. In this test case, the 3rd-order intermodulation distortion signals (PIM3) at a frequency of 877 MHz included in a receiving frequency band (BC0 RX) for telephone communication and generated by the filter 500 in the above Embodiment 1 had a strength of about −122 dBm. Under the same conditions, the 3rd-order intermodulation distortion signals (PIM3) at a frequency of 869 MHz included in a receiving frequency band (BC0 RX) for telephone communication and generated by a conventional filter having electrodes formed of a magnetic material had a strength of about −103 dBm.

### Embodiment 2

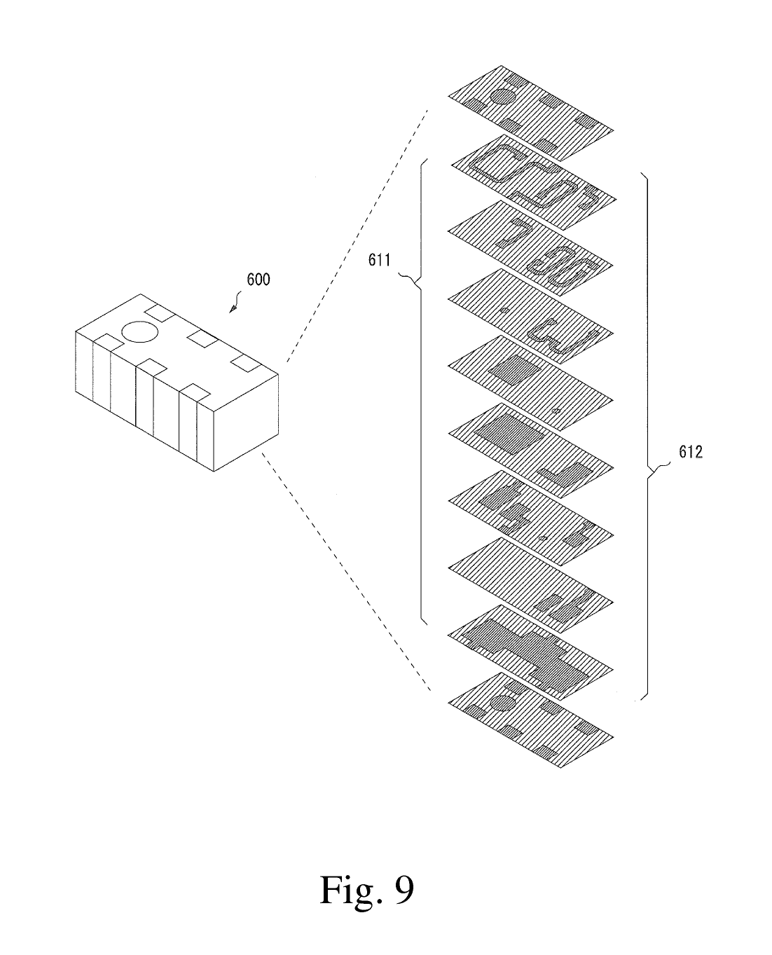

FIGS. 9 to 13 explain a diplexer 600 comprising a high-frequency electronic component that can be used as the diplexers 412, 422 of the communication device 10. As shown in FIG. 9, the diplexer 600 may comprise a laminated ceramic electronic component in the 2012 size that may have a plurality of internal electrodes inside a component body and external electrodes electrically connected to the internal electrodes on an outer surface of the component body.

As in Embodiment 1 described above, for example, the internal electrodes may be formed of silver (Ag); and the external electrodes may comprise: a silver (Ag) terminal electrode provided on the surface of the component body so as to be electrically connected to the internal electrodes; a copper (Cu) plated layer provided on the surface of the terminal electrode; and a tin (Sn) plated layer provided on the surface of the copper (Cu) plated layer.

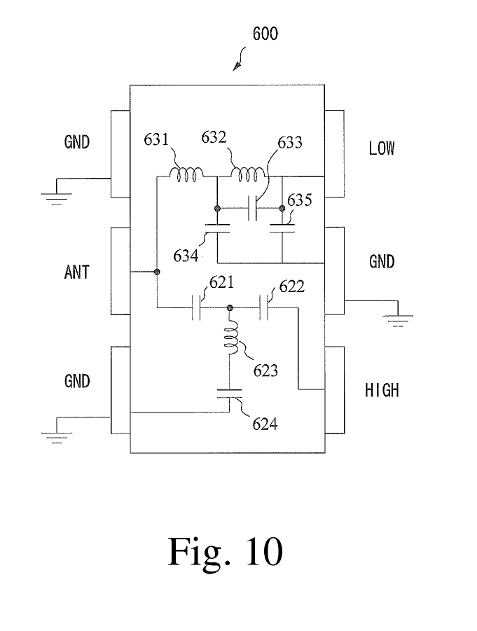

The component body may comprise a plurality of dielectric layers stacked together, each having formed thereon an internal electrode. These internal electrodes may constitute a high-pass filter unit 611 and a low-pass filter unit 612. The high-pass filter unit 611 may include capacitors 621, 622, 624 and inductor 623 shown in FIG. 10; and the low-pass filter unit 612 may include inductors 631, 632 and capacitors 633 to 635.

Embodiment 2 may also have the above features (A1) to (A4). As in Embodiment 1, the silver (Ag) terminal electrodes may be replaced with Ag—Pt baked terminal electrodes or Ag—Pd baked terminal electrodes to avoid plating.

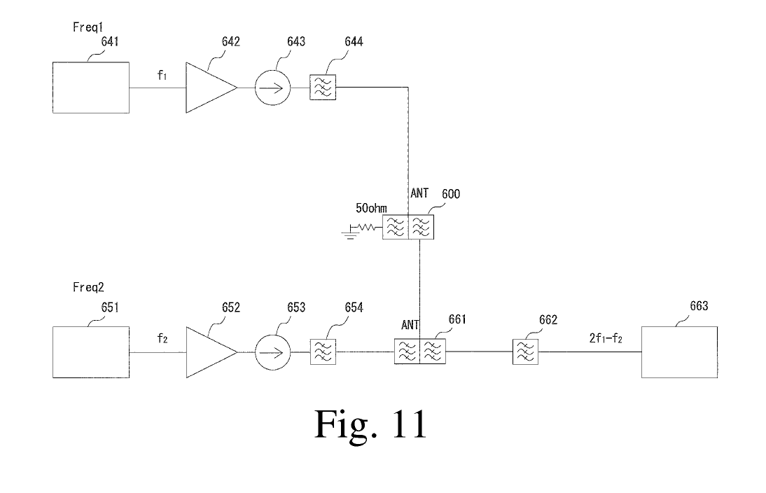

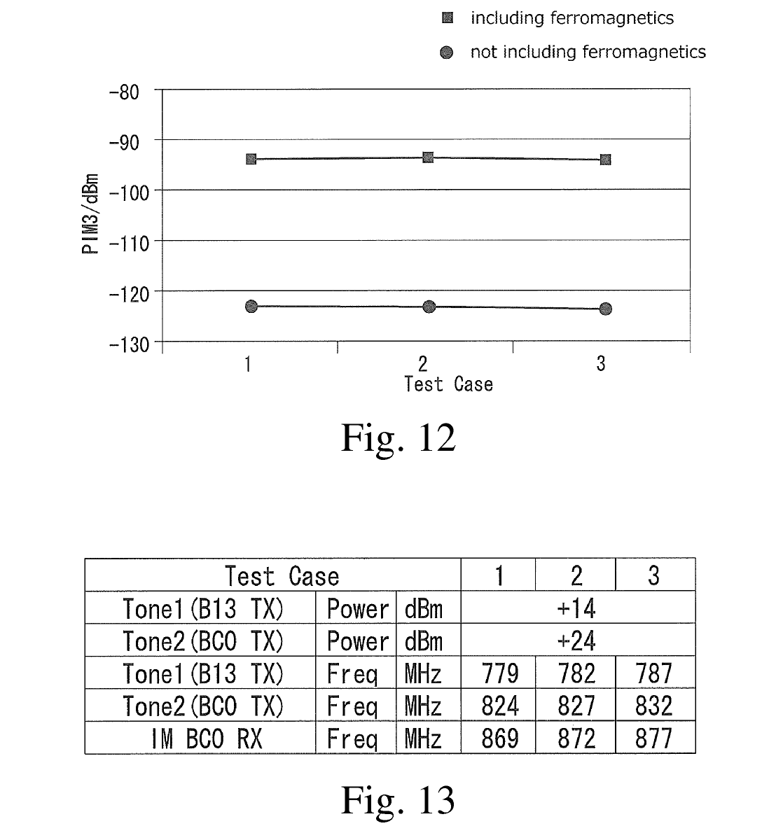

FIG. 12 shows the measurement result of 3rd-order intermodulation distortion produced by the diplexer 600 comprising the laminated ceramic electronic component having the electrodes formed of the nonmagnetic materials as described above. This measurement result was obtained with a measurement circuit shown in FIG. 11 under the measurement conditions shown in FIG. 13.

As shown in FIG. 11, high-frequency signals generated by a signal generator 641 for generating a frequency f1 for data communication may be amplified by a signal amplifier 642 and then inputted into the antenna connection terminal of the diplexer 600 via an isolator 643 and a filter 644. The diplexer 600, the object of the measurement, may be in the 2012 size. One of the input/output terminals of the diplexer 600 may be grounded via a 50Ω resistor. The isolator 643 may protect the signal amplifier 642 against reflection signals; and the filter 644 may remove spurious signals. The signal outputted from the duplexer 661 may be inputted into the diplexer 600.

High-frequency signals generated by a signal generator 651 for generating a frequency f2 for telephone communication may be amplified by a signal amplifier 652 and then inputted into one of input/output terminals of a duplexer 661 via an isolator 653 and a filter 654. The isolator 653 may protect the signal amplifier 652 against reflection signals; and the filter 654 may remove spurious signals.

The other input/output terminal of the duplexer 661 may be connected to a signal meter 663 via a filter 662 for removing spurious signals. Thus, the signal meter 663 may receive a signal of the frequency of 3rd-order intermodulation distortion (2f1−f2).

The measurement was based on test cases 1 to 3. In test case 1, the high-frequency signals (Tone 1 (B13 TX)) generated by the signal generator 641 and having a frequency for data communication had a strength of +14 dBm and a frequency of 779 MHz; and the high-frequency signals (Tone 2 (BC0 TX)) generated by the signal generator 651 and having a frequency for telephone communication had a strength of +24 dBm and a frequency of 824 MHz. In this test case, the 3rd-order intermodulation distortion signals (PIM3) at a frequency of 869 MHz included in a receiving frequency band (BC0 RX) for telephone communication and generated by the diplexer 600 in the above Embodiment 2 had a strength of about −123 dBm. Under the same conditions, the 3rd-order intermodulation distortion signals (PIM3) at a frequency of 869 MHz included in a receiving frequency band (BC0 RX) for telephone communication and generated by a conventional diplexer having electrodes formed of a magnetic material had a strength of about −94 dBm. The internal electrodes of the above conventional diplexer was formed of silver (Ag); and the external electrodes comprised: a silver (Ag) terminal electrode provided on the surface of the component body so as to be electrically connected to the internal electrodes; a nickel (Ni) plated layer provided on the surface of the terminal electrode; and a tin (Sn) plated layer provided on the surface of the nickel (Ni) plated layer.

In test case 2, the high-frequency signals (Tone 1 (B13 TX)) generated by the signal generator 641 and having a frequency for data communication had a strength of +14 dBm and a frequency of 782 MHz; and the high-frequency signals (Tone 2 (BC0 TX)) generated by the signal generator 651 and having a frequency for telephone communication had a strength of +24 dBm and a frequency of 827 MHz. In this test case, the 3rd-order intermodulation distortion signals (PIM3) at a frequency of 872 MHz included in a receiving frequency band (BC0 RX) for telephone communication and generated by the diplexer 600 in the above Embodiment 2 had a strength of about −123 dBm. Under the same conditions, the 3rd-order intermodulation distortion signals (PIM3) at a frequency of 869 MHz included in a receiving frequency band (BC0 RX) for telephone communication and generated by a conventional diplexer having electrodes formed of a magnetic material had a strength of about −94 dBm.

In test case 3, the high-frequency signals (Tone 1 (B13 TX)) generated by the signal generator 641 and having a frequency for data communication had a strength of +14 dBm and a frequency of 787 MHz; and the high-frequency signals (Tone 2 (BC0 TX)) generated by the signal generator 651 and having a frequency for telephone communication had a strength of +24 dBm and a frequency of 832 MHz. In this test case, the 3rd-order intermodulation distortion signals (PIM3) at a frequency of 877 MHz included in a receiving frequency band (BC0 RX) for telephone communication and generated by the diplexer 600 in the above Embodiment 2 had a strength of about −124 dBm. Under the same conditions, the 3rd-order intermodulation distortion signals (PIM3) at a frequency of 869 MHz included in a receiving frequency band (BC0 RX) for telephone communication and generated by a conventional diplexer having electrodes formed of a magnetic material had a strength of about −94 dBm.

### Embodiment 3

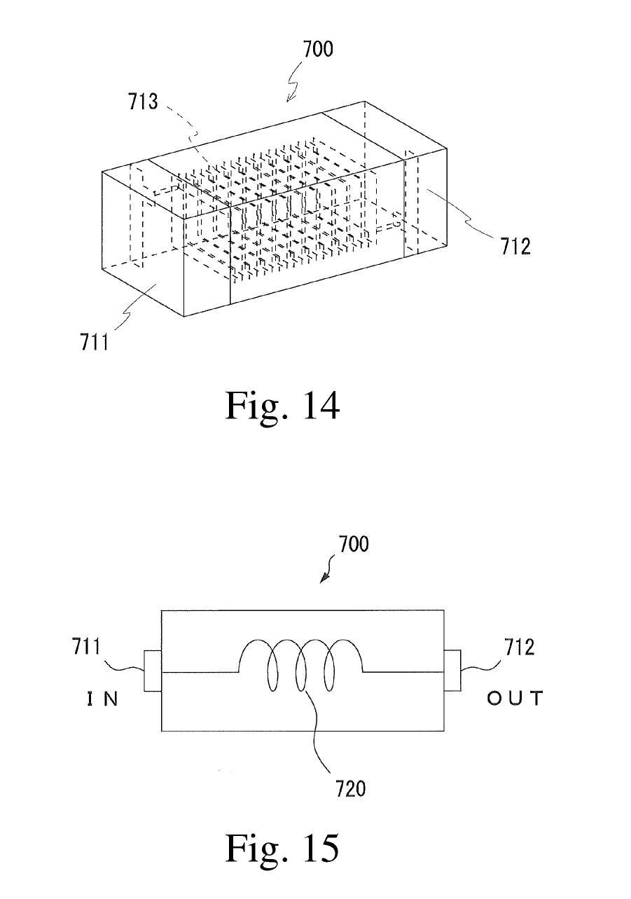

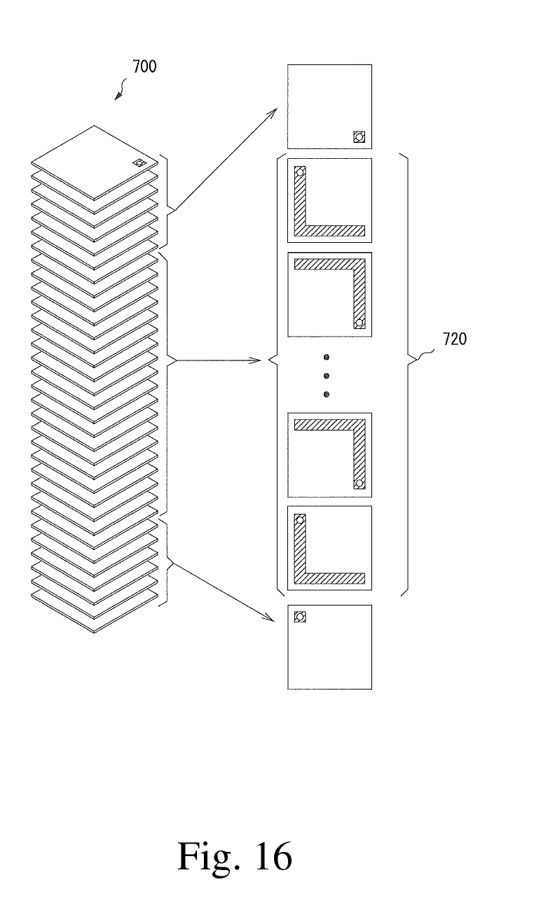

FIGS. 14 to 19 explain an inductor 700 comprising a high-frequency electronic component that can be used in the communication device 10. As shown in FIGS. 14 and 16, the inductor 700 may comprise a laminated ceramic electronic component that may have a plurality of internal electrodes 713 inside a component body and external electrodes 711, 712 electrically connected to the internal electrodes on an outer surface of the component body.

As in Embodiment 1 described above, for example, the internal electrodes may be formed of silver (Ag); and the external electrodes may comprise: a silver (Ag) terminal electrode provided on the surface of the component body so as to be electrically connected to the internal electrodes; a copper (Cu) plated layer provided on the surface of the terminal electrode; and a tin (Sn) plated layer provided on the surface of the copper (Cu) plated layer.

The component body may comprise a plurality of dielectric layer stacked together, each having formed thereon an internal electrode. These internal electrodes may constitute an inductor body 720.

Embodiment 3 may also have the above features (A1) to (A4). As in Embodiment 1, the silver (Ag) terminal electrodes may be replaced with Ag—Pt baked terminal electrodes or Ag—Pd baked terminal electrodes to avoid plating.

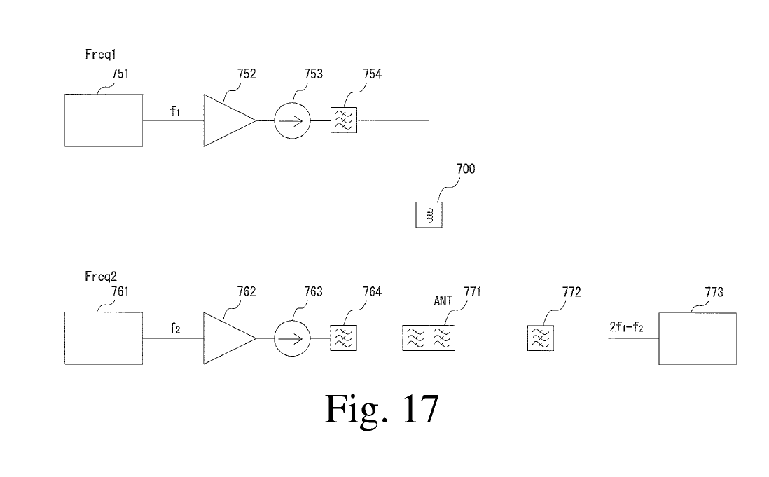

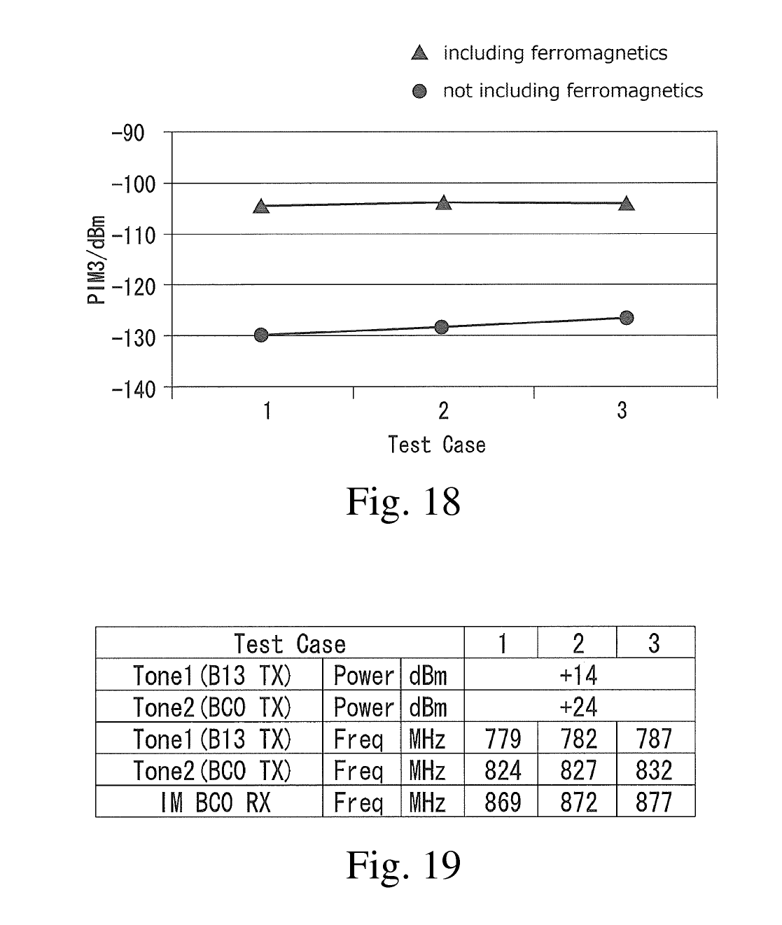

FIG. 18 shows the measurement result of 3rd-order intermodulation distortion produced by the inductor 700 comprising the laminated ceramic electronic component having the electrodes formed of the nonmagnetic materials as described above. This measurement result was obtained with a measurement circuit shown in FIG. 17 under the measurement conditions shown in FIG. 19.

As shown in FIG. 17, high-frequency signals generated by a signal generator 751 for generating a frequency f1 for data communication may be amplified by a signal amplifier 752 and then inputted into one of the terminals of the inductor 700 via an isolator 753 and a filter 754. The isolator 753 may protect the signal amplifier 752 against reflection signals; and the filter 754 may remove spurious signals.

High-frequency signals generated by a signal generator 761 for generating a frequency f2 for telephone communication may be amplified by a signal amplifier 762 and then inputted into one of input/output terminals of a duplexer 771 via an isolator 763 and a filter 764. The isolator 763 may protect the signal amplifier 762 against reflection signals; and the filter 764 may remove spurious signals. The signal outputted from the duplexer 771 may be inputted into the inductor 700.

The other input/output terminal of the duplexer 771 may be connected to a signal meter 773 via a filter 772 for removing spurious signals. Thus, the signal meter 773 may receive a signal of the frequency of 3rd-order intermodulation distortion (2f1−f2).

The measurement was based on test cases 1 to 3. In test case 1, the high-frequency signals (Tone 1 (B13 TX)) generated by the signal generator 751 and having a frequency for data communication had a strength of +14 dBm and a frequency of 779 MHz; and the high-frequency signals (Tone 2 (BC0 TX)) generated by the signal generator 761 and having a frequency for telephone communication had a strength of +24 dBm and a frequency of 824 MHz. In this test case, the 3rd-order intermodulation distortion signals (PIM3) at a frequency of 869 MHz included in a receiving frequency band (BC0 RX) for telephone communication and generated by the inductor 700 in the above Embodiment 3 had a strength of about −130 dBm. Under the same conditions, the 3rd-order intermodulation distortion signals (PIM3) at a frequency of 869 MHz included in a receiving frequency band (BC0 RX) for telephone communication and generated by a conventional inductor having electrodes formed of a magnetic material had a strength of about −104 dBm. The internal electrodes of the above conventional inductor was formed of silver (Ag); and the external electrodes comprised: a silver (Ag) terminal electrode provided on the surface of the component body so as to be electrically connected to the internal electrodes; a nickel (Ni) plated layer provided on the surface of the terminal electrode; and a tin (Sn) plated layer provided on the surface of the nickel (Ni) plated layer.

In test case 2, the high-frequency signals (Tone 1 (B13 TX)) generated by the signal generator 751 and having a frequency for data communication had a strength of +14 dBm and a frequency of 782 MHz; and the high-frequency signals (Tone 2 (BC0 TX)) generated by the signal generator 761 and having a frequency for telephone communication had a strength of +24 dBm and a frequency of 827 MHz. In this test case, the 3rd-order intermodulation distortion signals (PIM3) at a frequency of 872 MHz included in a receiving frequency band (BC0 RX) for telephone communication and generated by the inductor 700 in the above Embodiment 3 had a strength of about −128 dBm. Under the same conditions, the 3rd-order intermodulation distortion signals (PIM3) at a frequency of 869 MHz included in a receiving frequency band (BC0 RX) for telephone communication and generated by a conventional inductor having electrodes formed of a magnetic material had a strength of about −103 dBm.

In test case 3, the high-frequency signals (Tone 1 (B13 TX)) generated by the signal generator 751 and having a frequency for data communication had a strength of +14 dBm and a frequency of 787 MHz; and the high-frequency signals (Tone 2 (BC0 TX)) generated by the signal generator 761 and having a frequency for telephone communication had a strength of +24 dBm and a frequency of 832 MHz. In this test case, the 3rd-order intermodulation distortion signals (PIM3) at a frequency of 877 MHz included in a receiving frequency band (BC0 RX) for telephone communication and generated by the inductor 700 in the above Embodiment 3 had a strength of about −127 dBm. Under the same conditions, the 3rd-order intermodulation distortion signals (PIM3) at a frequency of 869 MHz included in a receiving frequency band (BC0 RX) for telephone communication and generated by a conventional inductor having electrodes formed of a magnetic material had a strength of about −104 dBm.

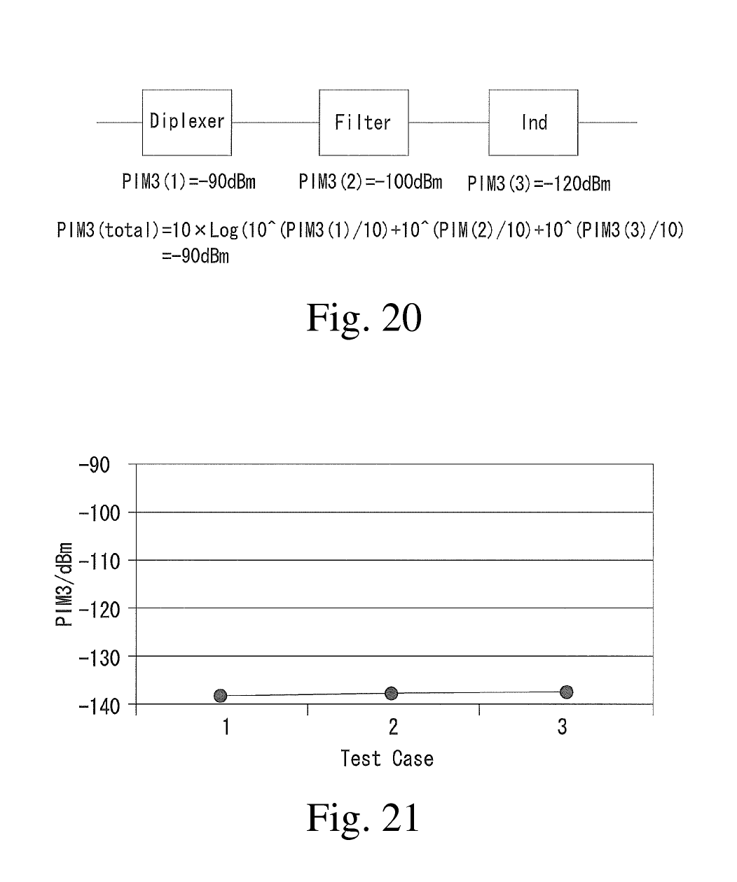

When a plurality of electronic components that pass high-frequency signal current are connected in series between an antenna and a mixer in a transmitting/receiving unit as in FIG. 20, the total amount of 3rd-order intermodulation distortion may be large in the case where any one of the above plurality of electronic components produces a large 3rd-order intermodulation distortion. In FIG. 20, the first stage is a diplexer that may produce −90 dBm of 3rd-order intermodulation distortion, followed by a filter that may produce −100 dBm of 3rd-order intermodulation distortion, and followed by an inductor that may produce −120 dBm of 3rd-order intermodulation distortion. In this case, the total amount of 3rd-order intermodulation distortion (PIM) may be −90 dBm.

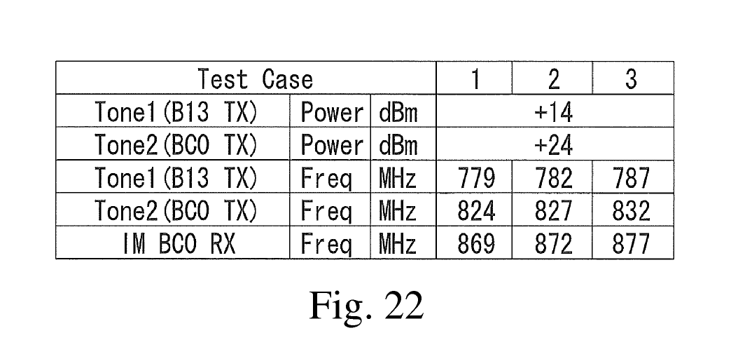

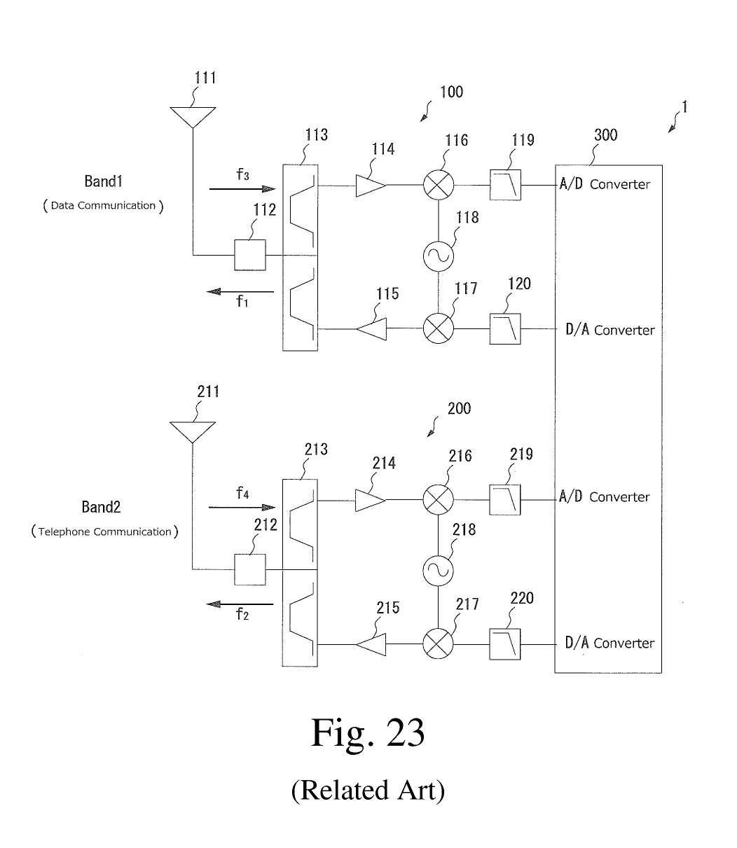

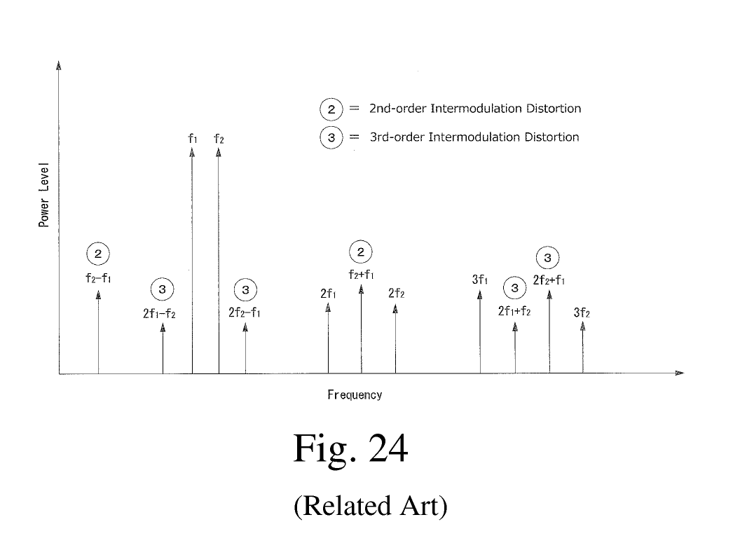

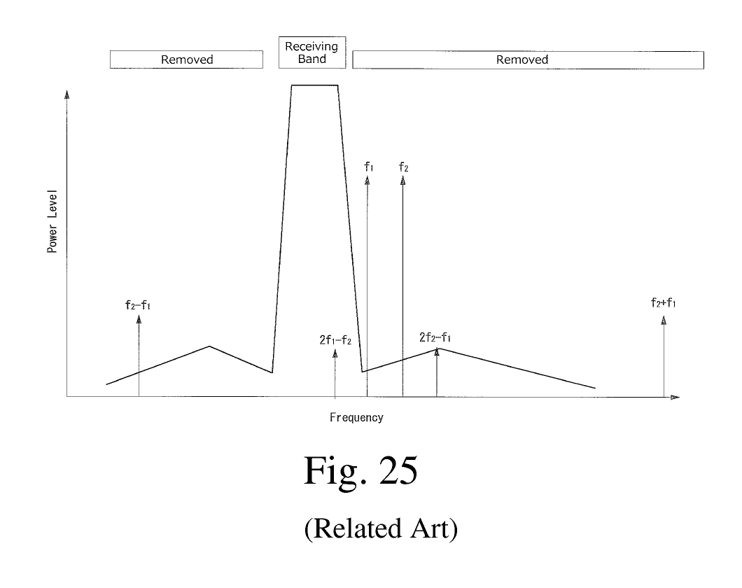

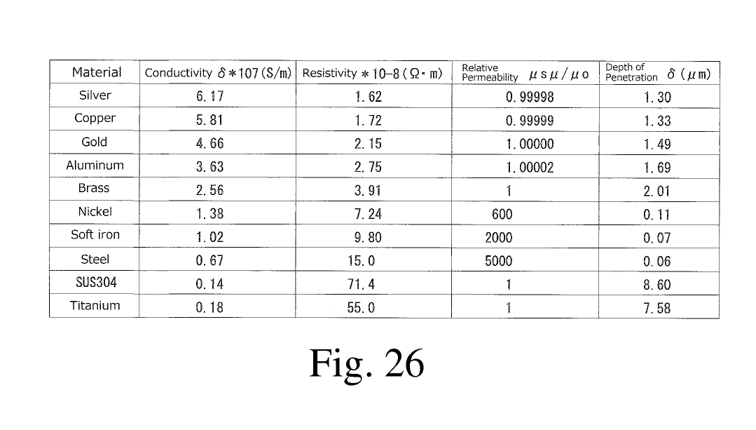

Further, the measurement circuit as used for Embodiment 1 was used to measure 3rd-order intermodulation produced in printed wiring formed of a nonmagnetic material (e.g., copper (Cu)) on the printed wiring board having formed thereon the first transmitting/receiving unit 110 and the second transmitting/receiving unit 210. The measurement result and the measurement conditions are shown in FIG. 21 and FIG. 22, respectively.

In test case 1, the high-frequency signals (Tone 1 (B13 TX)) generated by the signal generator 531 and having a frequency for data communication had a strength of +14 dBm and a frequency of 779 MHz; and the high-frequency signals (Tone 2 (BC0 TX)) generated by the signal generator 541 and having a frequency for telephone communication had a strength of +24 dBm and a frequency of 824 MHz. In this test case, the 3rd-order intermodulation distortion signals (PIM3) at a frequency of 869 MHz included in a receiving frequency band (BC0 RX) for telephone communication and generated by the printed wiring had a strength of about −138 dBm.

In test case 2, the high-frequency signals (Tone 1 (B13 TX)) generated by the signal generator 531 and having a frequency for data communication had a strength of +14 dBm and a frequency of 782 MHz; and the high-frequency signals (Tone 2 (BC0 TX)) generated by the signal generator 541 and having a frequency for telephone communication had a strength of +24 dBm and a frequency of 827 MHz. In this test case, the 3rd-order intermodulation distortion signals (PIM3) at a frequency of 872 MHz included in a receiving frequency band (BC0 RX) for telephone communication and generated by the printed wiring had a strength of about −138 dBm.

In test case 3, the high-frequency signals (Tone 1 (B13 TX)) generated by the signal generator 531 and having a frequency for data communication had a strength of +14 dBm and a frequency of 787 MHz; and the high-frequency signals (Tone 2 (BC0 TX)) generated by the signal generator 541 and having a frequency for telephone communication had a strength of +24 dBm and a frequency of 832 MHz. In this test case, the 3rd-order intermodulation distortion signals (PIM3) at a frequency of 877 MHz included in a receiving frequency band (BC0 RX) for telephone communication and generated by the printed wiring had a strength of about −138 dBm.

The high-frequency electronic components that can be applied to the communication device of the present disclosure are not limited to filters, diplexers, and inductors described in the above embodiments, but also includes duplexers, capacitors, low-pass filters, high-pass filters, notch filters, bandpass filters, band elimination filters, and combinations thereof, as well as other high-frequency electronic components. Communication devices including ceramic high-frequency electronic components employing the present disclosure may produce the same effect as the above embodiments.

The present disclosure enables a communication device that permits simultaneous communication of audio and data to suppress 3rd-order intermodulation distortion. Therefore, the reproducibility of the received signals can be maintained.

What is claimed is:

1. A communication device comprising:
a first transmitting/receiving unit configured to transmit a radio wave having a first frequency f1 within a first frequency band and receive a radio wave having a third frequency f3 within a third frequency band different from the first frequency band; and
a second transmitting/receiving unit configured to transmit a radio wave having a second frequency f2 within a second frequency band different from the first and third frequency bands and receive a radio wave having a fourth frequency f4 within a fourth frequency band different from the first to third frequency bands,
wherein the first transmitting/receiving unit and the second transmitting/receiving unit are capable of transmitting or receiving simultaneously,
the first to fourth frequency bands are set such that a frequency component of any one of a plurality of 3rd-order intermodulation distortions produced from the first frequency f1 and the second frequency f2 is included in at least one of the third frequency band and the fourth frequency band used as receiving frequency bands, and
high-frequency electronic components conducting high frequency electric current having a frequency within any of the first to fourth frequency bands have electrodes formed of a nonmagnetic metal.

2. The communication device of claim 1 wherein the electrodes include external electrodes and internal electrodes of the high-frequency electronic components.

3. The communication device of claim 1 wherein the high-frequency electronic components comprise one or more of a diplexer, low-pass filter, high-pass filter, bandpass filter, notch-type filter, band elimination filter, duplexer, inductor, and capacitor, or a combination of these components.
